(19) United States
(12) Patent Application Publication
(10) Pub. No.: US 2025/0094076 A1
(43) Pub. Date: Mar. 20, 2025

(54) STORAGE SYSTEM AND OPERATION METHOD THEREOF

(71) Applicant: MACRONIX INTERNATIONAL CO., LTD., Hsinchu (TW)

(72) Inventors: Chiao-Wen YEH, New Taipei City (TW); Hsiang-Lan LUNG, Kaohsiung City (TW)

(21) Appl. No.: 18/467,818

(22) Filed: Sep. 15, 2023

(51) Int. Cl. G06F 3/06

(52) U.S. Cl. CPC G06F 3/0655; G06F 3/0611; G06F 3/0679

(57) ABSTRACT

The invention provides a storage system and an operation method thereof. The operating method includes: when a first data is written into the storage system, the memory control circuit dividing the first data into a first part and a second part; the memory control circuit writing the first part of the first data to the first type memory; and the memory control circuit writing the second part of the first data to the second type memory. A data amount of the first part of the first data is related to a read latency difference and a data transfer rate of the second type memory. The read latency difference is related to the first read latency of the first type memory and the second read latency of the second type memory.

### TECHNICAL FIELD

The disclosure relates in general to a storage system and an operation method thereof.

### BACKGROUND

Currently, NAND flash memory and DRAM (Dynamic Random Access Memory) are common types of memory.

NAND flash memory is widely popular for several reasons: (1) High-density storage: NAND flash can store a large amount of data in a relatively small physical space, making it an ideal choice for smartphones, tablet computers, and solid-state drives (SSDs). (2) Non-volatile: NAND flash is non-volatile, meaning it retains stored data even when the power is off. This contrasts with DRAM, which loses its stored data without power. (3) Durability: Compared to traditional hard disk drives (HDDs), NAND flash is more durable and can withstand shocks and impacts. (4) Low power consumption: NAND flash consumes relatively low power during operation, making it especially suitable for mobile devices like smartphones and laptops. (5) Decent read speeds: While NAND's write and read speeds are not extremely fast, they are sufficient for many applications. (6) Price: With advancements in manufacturing technology and the effects of economies of scale, the price of NAND flash has significantly decreased, making it an economical choice for many consumer electronics. (7) Technological advancements: In recent years, the development of multi-level storage technologies, such as 3D NAND, has further improved the storage density and performance of NAND flash.

In summary, NAND flash memory combines various advantages, making it the mainstream storage solution in the current electronics market.

DRAM (Dynamic Random Access Memory) is also a common computer memory technology, with the following benefits: (1) High-speed performance: DRAM has very fast read and write speeds, especially compared to NAND flash and other storage technologies. (2) Simple architecture: The cell structure of DRAM is relatively simple, making it easier to achieve high density during manufacturing. (3) Gradually decreasing costs: Due to DRAM's simple structure and high-volume manufacturing, its production costs are gradually decreasing. (4) Scalability: With advancements in semiconductor technology, the density and performance of DRAM continue to improve, meeting the growing performance demands. (5) Low power modes: Many modern DRAM technologies, such as LPDDR SDRAM (low power Double Data Rate Synchronous Dynamic Random Access Memory), offer low power modes, helping to extend battery life. (6) Broad support: DRAM technology has been around for a long time, so it has widespread support in both hardware and software.

For NAND flash memory, even the most advanced models on the market today, the read and write speeds of NAND flash are still inferior to DRAM. Specifically, the latency of NAND is a few tens of microseconds, while DRAM only requires a few tens of nanoseconds. The difference in latency is mainly due to the storage operation methods, not the data transfer speed. Therefore, even increasing the I/O count of NAND cannot effectively improve bandwidth and thus mitigate this latency.

Therefore, this invention proposes a system design that effectively reduces the latency issues brought by NAND flash memory by adding a small amount of DRAM and systematically changing the movement of data.

### SUMMARY

According to one embodiment, a method of operating a storage system is provided. The storage system comprises a memory control circuit, a first type memory, and a second type memory, a first read latency of the first type memory being shorter than a second read latency of the second type memory. The operating method includes: when a first data is written into the storage system, the memory control circuit dividing the first data into a first part and a second part; the memory control circuit writing the first part of the first data to the first type memory; and the memory control circuit writing the second part of the first data to the second type memory, wherein, a data amount of the first part of the first data is related to a read latency difference and a data transfer rate of the second type memory, the read latency difference is related to the first read latency of the first type memory and the second read latency of the second type memory.

According to another embodiment, a storage system is provided. The storage system comprises: a memory control circuit; a first type memory, coupled to the memory control circuit; and a second type memory, coupled to the memory control circuit. A first read latency of the first type memory is shorter than a second read latency of the second type memory. When a first data is written into the storage system, the memory control circuit divides the first data into a first part and a second part. The memory control circuit writes the first part of the first data to the first type memory and writes the second part of the first data to the second type memory. A data amount of the first part of the first data is related to a read latency difference and a data transfer rate of the second type memory. The read latency difference is related to the first read latency of the first type memory and the second read latency of the second type memory.

### BRIEF DESCRIPTION OF THE DRAWINGS

FIG. 1 shows a functional block diagram of a storage system according to one embodiment of the present invention.

FIG. 2 shows a read schematic of the first type memory and the second type memory according to one embodiment of the present invention.

FIG. 3 shows a schematic diagram of the write operation of the storage system according to one embodiment of the invention.

FIG. 4 shows a schematic diagram of the read operation of the storage system according to one embodiment of the invention.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DESCRIPTION OF THE EMBODIMENTS

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

In one embodiment of the present invention, input data is written into at least two types of memory with different latency. When input data is written into the storage system, it is divided into two parts. During the write operation, the first part of the input data is written into the first type memory with shorter latency (e.g., but not limited to, DRAM), while the second part of the input data is concurrently written into the second type memory with longer latency (e.g., but not limited to, NAND flash memory). Therefore, for write operations, the overall write latency of the storage system will be very close to that of the first type memory with shorter latency. For read operations, data will be read in parallel from the first and second types of memory and recombined by the memory control circuit to obtain complete data. Thus, for read operations, the overall read latency of the storage system will be very close to that of the first type memory with shorter latency.

That is, in one embodiment of the present invention, two different latency memories are used to optimize data read and write speeds. This embodiment of the invention maximizes data read and write efficiency by using two different latency memories simultaneously, providing an efficient and competitive solution.

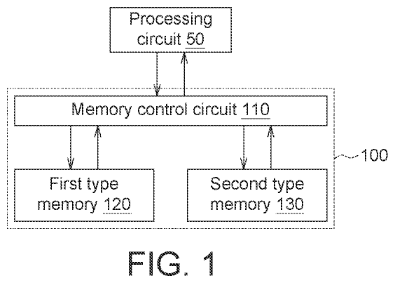

FIG. 1 shows a functional block diagram of a storage system according to one embodiment of the present invention. As shown in FIG. 1, the storage system 100 of one embodiment of the present invention includes: a memory control circuit 110, a first type memory 120, and a second type memory 130. The memory control circuit 110 is coupled to the first type memory 120 and the second type memory 130. The memory control circuit 110 is further coupled to processing circuit 50 (e.g., but not limited to, a central processing unit CPU).

The memory control circuit 110 includes a plurality of hardware control circuits to control the first type memory 120 and the second type memory 130.

The first type memory 120 includes a plurality of hardware circuits to store data. In one possible example, the first type memory 120 is, for instance but not limited to, DRAM, which has shorter read/write latency and faster read/write speeds.

The second type memory 130 includes a plurality of hardware circuits to store data. In one possible example, the second type memory 130 is, for instance but not limited to, NAND flash memory, which has longer read/write latency and slower read/write speeds compared to the first type memory 120.

Of course, the invention is not limited to this. According to the spirit of the invention, other possible embodiments of the storage system of the invention can include three or more different types of memory, with different latency for each of these three or more different types of memory. This is also within the scope of the spirit of the invention.

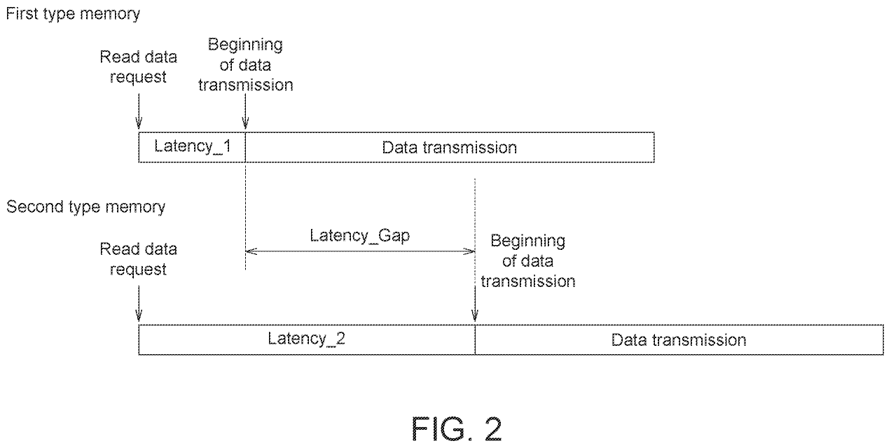

FIG. 2 shows a read schematic of the first type memory 120 and the second type memory 130 according to one embodiment of the present invention. In FIG. 2, the first read latency Latency_1 of the first type memory 120 is shorter than the second read latency Latency_2 of the second type memory 130. The read latency difference Latency_Gap represents the difference between the first read latency Latency_1 of the first type memory 120 and the second read latency Latency_2 of the second type memory 130 (Latency_Gap=Latency_2−Latency_1).

Memory read latency refers to the time from when the memory receives a memory read data request to when the memory starts transmitting data. The lower the read latency, the faster the system response speed. Low latency memory is more expensive (higher cost per bit) and has a lower density, while high latency memory will reduce the overall system's computational performance. Therefore, one embodiment of the present invention proposes a hybrid memory composed of two types of memory, with short latency and high memory density, without significantly increasing costs. That is, this embodiment of the invention seeks a solution that finds a balance between performance, capacity, and cost.

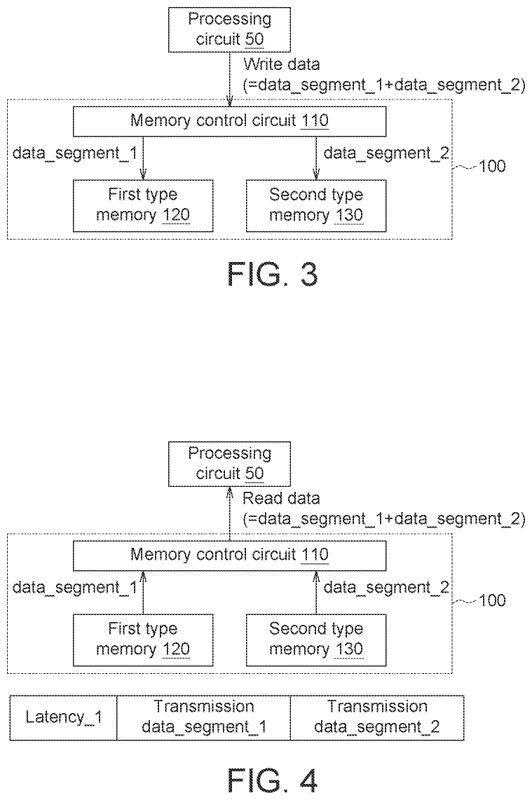

FIG. 3 shows a schematic diagram of the write operation of the storage system according to one embodiment of the invention. For the write process of the hybrid memory combining the short-latency first type memory 120 and the long-latency, high-storage-density second type memory 130, the write data (sent from processing circuit 50 to memory control circuit 110) is divided into two parts by memory control circuit 110: the first part data_segment_1 and the second part data_segment_2. The first part data_segment_1 of the write data is written to the faster first type memory 120 to achieve short-latency performance. The second part data_segment_2 of the write data is written to the high-density long-latency second type memory 130.

The data amount of the first part data_segment_1 of the write data is related to the read latency difference Latency_Gap and the data transfer rate Data_Transfer_Rate_2 of the second type memory 130. For example, but not limited to, the data amount of the first part data_segment_1 of the write data can be represented as: data_segment_1=Latency_Gap*Data_Transfer_Rate_2. The data amount of the first part data_segment_1 is the product of the read latency difference Latency_Gap and the data transfer rate Data_Transfer_Rate_2 of the second type memory 130.

For instance, if the first read latency Latency_1 of the first type memory 120 and the second read latency Latency_2 of the second type memory 130 are 20 ns and 20 μs respectively, and the data transfer rate Data_Transfer_Rate_2 of the second type memory 130 is 3.2 GB/s, then the data amount of the first part data_segment_1 of the write data is: data_segment_1=Latency_Gap*Data_Transfer_Rate_2=(20 us−20 ns)×3.2 GB/s≈20×10⁻⁶×6.4×10⁹≈64 KB. That is, when writing data, the input data will be divided into two parts by the memory control circuit 110: the first part data_segment_1 (with a data amount of approximately 64 KB) and the second part data_segment_2 (the remaining part). The 64 KB of the input data will be written to the faster first type memory 120, while the remaining part of the input data will be written to the high-density but long-latency second type memory 130.

Moreover, in one embodiment of the invention, even if the data transfer rates of the first type memory 120 and the second type memory 130 are different, it will not overly affect the desired effect of this embodiment.

That is, in one embodiment of the invention, since the storage system 100 is a hybrid memory system, comprising the short-latency first type memory 120 and the long-latency, high-storage-density second type memory 130, this embodiment provides a data writing strategy aimed at ensuring the advantages of high-speed read/write and large capacity simultaneously.

FIG. 4 shows a schematic diagram of the read operation of the storage system according to one embodiment of the invention. During reading, the memory control circuit 110 receives a read instruction and read address sent from the processing circuit 50. In response, the memory control circuit 110 parallel reads the first part data_segment_1 of the data from the first type memory 120 and the second part data_segment_2 of the data from the second type memory 130. The memory control circuit 110 combines the first part and the second part into the read data (read data=data_segment_1+data_segment_2) and sends back to the processing circuit 50.

During the read operation, simultaneous read operations can be performed on the first type memory 120 and the second type memory 130.

Since the first type memory 120 has shorter latency, after the first read latency Latency_1 of the first type memory 120, the first part data_segment_1 of the data will be returned to the memory control circuit 110 from the first type memory 120 before the second part data_segment_2 of the data is returned from the second type memory 130 with longer latency.

For the read process of storage system 100 (a hybrid memory system), in data read, the memory control circuit 110 reads both the first part data_segement_1 and the second part data_segement_2. Since these two parts of data are stored in two different memories (the short-latency first type memory 120 and the long-latency, high-storage-density second type memory 130), the read operation will be performed synchronously in these two memories.

Since the first type memory 120 has shorter latency, the first part data_segement_1 of the data stored in the first type memory 120 will be read out faster than the second part data_segement_2 of the data stored in the long-latency, high-storage-density second type memory 130. Therefore, when the memory control circuit 110 starts outputting data to the processing circuit 50, the first part data_segement_1 is output first, followed by the second part data_segement_2. This reading strategy ensures that data can be read out continuously at the fastest speed.

Since the two types of memory have different read and write latencies, the memory with slower read and write speeds will dominate the final read and write latency of the storage system in prior art. However, in this embodiment, through the aforementioned read and write strategy, data can be read out continuously at the fastest speed; and for read operations, the overall read latency of the storage system 100 will be very close to the shorter read latency of the first type memory 120.

In practice, in this embodiment, the first type memory 120 and the second type memory 130 can be integrated into the same memory card or the same dual in-line memory module (DIMM). This memory card or DIMM contains an internal memory control circuit (internal control) that can perform the operations and functions of the memory control circuit 110 shown in FIG. 1. In other words, the memory control circuit 110 from FIG. 1 is located inside this memory card or DIMM.

Alternatively, in another embodiment, the first type memory 120 and the second type memory 130 can be integrated into the same memory card or the same DIMM, but the functions and operations of the memory control circuit 110 from FIG. 1 can be executed by the host's processing circuit (such as a CPU) (external control). That is, the memory control circuit 110 from FIG. 1 is located outside this memory card or DIMM.

Or, in this embodiment, the first type memory 120 and the second type memory 130 are located in two separate memory cards or two separate DIMMs. Both of these separate memory cards or DIMMs contain an internal memory control circuit (internal control) that can perform the operations and functions of the memory control circuit 110 shown in FIG. 1. In other words, the memory control circuit 110 from FIG. 1 is located inside these two separate memory cards or DIMMs.

Alternatively, in another embodiment, the first type memory 120 and the second type memory 130 are located in two separate memory cards or two separate DIMMs, but the functions and operations of the memory control circuit 110 from FIG. 1 can be executed by the host's processing circuit (such as a CPU) (external control). That is, the memory control circuit 110 from FIG. 1 is located outside these two separate memory cards or DIMMs.

This embodiment is not limited to specific types of memory and can be applied to various different memory and storage technologies, including SRAM (Static Random Access Memory), DRAM (Dynamic Random Access Memory), NAND flash memory, NOR flash memory, hard disk drives, ROM (Read-Only Memory), RRAM (Resistive Random Access Memory), MRAM (Magnetoresistive Random Access Memory), and FeRAM (Ferroelectric Random Access Memory), etc.

Furthermore, in other possible embodiments, the data amount of the first part data_segment_1 can also be obtained by different relationships of the read latency difference (Latency_Gap) and the data transfer rate (Data_Transfer_Rate_2). This is also within the spirit of this invention, as long as it maximizes transmission efficiency. The data amount of the first part data_segment_1 can also be adjusted based on different system design requirements or considerations.

This embodiment discloses a new memory technology or system that combines two memories with different characteristics to achieve optimal performance and cost benefits. As known, in memory technology, short-latency memories, such as DRAM, provide fast data access, but they are more expensive to manufacture and have lower storage density. In contrast, long-latency memories, such as NAND flash memory, offer larger storage density and lower costs, but their access speeds are slower. This embodiment proposes a new method, combining these two types of memory, to achieve the advantages of short latency, high density, and low cost. The hybrid memory system of this embodiment includes a fast, high-cost first type memory (such as DRAM) and a slow, high-storage-density, low-cost second type memory (such as NAND flash memory). To make these two types of memory work together, this embodiment also discloses a memory control circuit (with a plurality of hardware control circuits) to manage data access and transmission. In read operations, when the slow, high-storage-density, low-cost second type memory (such as NAND flash memory) is still preparing for data transmission (i.e., within the latency time Lantency_2), the fast, high-cost first type memory (such as DRAM) might already be ready to transmit data to the memory control circuit. The read and write strategy of this embodiment ensures that even if the slow, high-storage-density, low-cost second type memory (such as NAND flash memory) is used, the storage system of this embodiment can still access or transmit data quickly. Therefore, the overall latency of the storage system of this embodiment is similar to the overall latency of using only the fast, high-cost first type memory (such as DRAM).

In summary, the hybrid storage system of this embodiment combines the advantages of short-latency memory and high-density memory and uses a specific memory control circuit and data transfer/combination strategy to achieve optimal performance.

This embodiment is suitable for working memories, computational memories, or storage memories. Furthermore, this embodiment can be applied to both non-volatile memory and volatile memory.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method of operating a storage system comprising a memory control circuit, a first type memory, and a second type memory, a first read latency of the first type memory being shorter than a second read latency of the second type memory, the operating method including:
in response that a first data is written into the storage system, the memory control circuit dividing the first data into a first part and a second part;
the memory control circuit writing the first part of the first data to the first type memory; and
the memory control circuit writing the second part of the first data to the second type memory,
wherein, a data amount of the first part of the first data is related to a data transfer rate of the second type memory and a read latency difference,
the read latency difference is related to the first read latency of the first type memory and the second read latency of the second type memory.

2. The method of operating the storage system as described in claim 1, wherein the read latency difference is a difference between the first read latency of the first type memory and the second read latency of the second type memory.

3. The method of operating the storage system as described in claim 1, wherein the first part of the first data is a product of the read latency difference and a data transfer rate of the second type memory.

4. The method of operating the storage system as described in claim 1, wherein
in response to reading the first data from the storage system, the memory control circuit concurrently reading the first part of the first data from the first type memory and the second part of the first data from the second type memory; and
the memory control circuit combining the first part of the first data with the second part of the first data to form the first data and returning the first data.

5. A storage system, comprising:
a memory control circuit;
a first type memory, coupled to the memory control circuit; and
a second type memory, coupled to the memory control circuit,
wherein,
a first read latency of the first type memory is shorter than a second read latency of the second type memory,
in response that a first data is written into the storage system, the memory control circuit divides the first data into a first part and a second part,
the memory control circuit writes the first part of the first data to the first type memory and writes the second part of the first data to the second type memory,
a data amount of the first part of the first data is related to a data transfer rate of the second type memory and a read latency difference, and
the read latency difference is related to the first read latency of the first type memory and the second read latency of the second type memory.

6. The storage system as described in claim 5, wherein the read latency difference is a difference between the first read latency of the first type memory and the second read latency of the second type memory.

7. The storage system as described in claim 5, wherein the first part of the first data is a product of the read latency difference and a data transfer rate of the second type memory.

8. The storage system as described in claim 5, wherein,
for a read operation, the memory control circuit concurrently reads the first part of the first data from the first type memory and the second part of the first data from the second type memory; and
the memory control circuit combines the first part of the first data with the second part of the first data to form the first data.

9. The storage system as described in claim 5, wherein,
the first type memory and the second type memory are integrated within the same memory card or the same dual in-line memory module (DIMM); and
the memory control circuit is located within the memory card or the DIMM.

10. The storage system as described in claim 5, wherein,
the first type memory and the second type memory are integrated within the same memory card or the same dual in-line memory module (DIMM); and
the memory control circuit is located outside the memory card or the DIMM.

11. The storage system as described in claim 5, wherein,
the first type memory and the second type memory are respectively located within two separate memory cards or two separate dual in-line memory modules (DIMMs); and
the memory control circuit is located within the two separate memory cards or the two separate DIMMs.

12. The storage system as described in claim 5, wherein,
the first type memory and the second type memory are respectively located within two separate memory cards or two separate dual in-line memory modules (DIMMs); and
the memory control circuit is located outside the two separate memory cards or the two separate DIMMs.
